(19) United States
(12) Patent Application Publication
(10) Pub. No.: US 2023/0025978 A1
(43) Pub. Date: Jan. 26, 2023

(54) DEVICE AND METHOD FOR SETTING A PRESSURE IN A SYSTEM

(71) Applicant: Harald BRACH, Wildpoldsried (DE)

(72) Inventor: Harald BRACH, Wildpoldsried (DE)

(21) Appl. No.: 17/778,711

(22) PCT Filed: Nov. 19, 2020
(86) PCT No.: PCT/EP2020/082697

§ 371 Date: May 20, 2022

(30) Foreign Application Priority Data
Nov. 21, 2019 (DE) 10 2019 217 994.0

(51) Int. Cl. B29C 73/02; G05D 16/20; B05C 5/02; B32B 17/10

(52) U.S. Cl. CPC B29C 73/025; G05D 16/202; B05C 5/02; B32B 17/10963; B29L 2031/3052

(57) ABSTRACT

The present invention relates to a device for adjusting a pressure in a system. The device comprises at least one movable adjustment unit having at least one opening and a fluid passage. The fluid passage comprises a main opening having a flow area for discharging a main stream of fluid to be conducted through the fluid passage, and a by-pass opening having a flow area for discharging a secondary stream of the fluid to be conducted through the fluid passage into an outside environment of the device. The adjustment unit is configured to, in a working position, at least partially overlap the by-pass opening and thereby reduce the flow area of the by-pass opening

### RELATED APPLICATION INFORMATION

This patent claims priority from International PCT Patent Application No. PCT/EP2020/082697, filed Nov. 19, 2020 entitled, “DEVICE AND METHOD FOR SETTING A PRESSURE IN A SYSTEM”, which claims priority to European Patent Application No. 102019217994.0, filed Nov. 21, 2019, all of which are incorporated herein by reference in their entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

The present invention relates to a method and a device for adjusting a pressure in a system as well as the corresponding system.

Several applications are based on applying a pressure to a device, which is provided by a pump, for example. However, due to their configuration, pumps usually show a deviation in the pressure they provide

Pumps are known that show a minimal deviation in their provided pressure behavior. However, such pumps are usually technically complex and therefore expensive.

Repair systems can be used to repair damaged areas, e.g. in vehicle windscreens, by filling the damaged area with a filling agent and thereby repairing it.

WO 2018/100100 A1 discloses a method and a device for repairing damaged areas, wherein a damaged area is applied with different pressures in a series of pressure phases to enable a particularly thorough filling of a damaged area with filling agent.

In order to avoid damage to an object to be repaired, such as a windscreen, it is important and advantageous to maintain an exact pressure at the desired point of damage.

It was therefore a task of the present invention to provide an accurate and flexible adjustment of a pressure in a system.

In order to solve the aforementioned problem, the present invention relates in a first aspect to a device for adjusting a pressure in a system. The device comprises at least one movable adjustment unit with at least one opening and a fluid passage. The fluid passage comprises a by-pass opening for discharging a by-pass stream of a fluid flowing through the fluid passage into an outside environment of the device or for entry of a secondary stream from the outside environment of the device into the fluid passage, and a main opening. The adjustment unit is configured to at least partially overlap the by-pass opening in a working position, thereby reducing the flow area of the by-pass opening.

According to the present invention, an adjustment unit is to be understood as an element which has at least one opening and which is movably arranged in the device. The adjustment unit may be formed as a disc, cuboid or any other geometric object.

According to the present invention, a flow region is to be understood as a region in which a fluid flows. In particular, a flow area may be a surface of an opening of a fluid passage, such as a surface of a secondary opening, i.e. a so-called “by-pass opening”.

According to the present invention, a by-pass opening is understood to be an area-wise overlapping of an element, such as the adjustment unit, at a fluid passage comprising the by-pass opening, in which the adjustment unit covers or reduces a flow area of the by-pass opening in an area-wise manner and a discharge of fluid from the by-pass opening is only possible through an exposed are. In particular, the by-pass opening may be overlapped by an opening in an adjustment unit which suitably exposes a flow area for flowing a fluid from the by-pass opening through the opening of the adjustment unit. A diameter of the opening of the adjustment unit may be selected such that a material of the adjustment unit surrounding or providing the opening partially overlaps the flow area of the by-pass opening, such as when the opening of the adjustment unit is smaller than the by-pass opening.

The present invention particularly aims to reduce or influence an inlet pressure, which is provided by a pump for example, in a controlled manner to achieve or to provide an exact working pressure, wherein the working pressure can also be negative in the case of a low-pressure. According to the invention, a fluid passage is provided for this purpose, which comprises a main opening and a by-pass opening.

The present invention is based on a secondary stream or a so-called “compulsory leakage”. The secondary stream can be discharged from a fluid stream flowing with a high-pressure or from a fluid passage with a high-pressure. In particular, it may be provided that the fluid stream is divided into a main stream in a main fluid passage and a secondary stream in a secondary fluid passage, wherein the main stream flows or is kept constant at a reduced working pressure compared to the fluid stream. Alternatively, the secondary stream can be fed to a main stream subjected to a low-pressure in order to distribute the low-pressure over a larger fluid quantity and, as a result, reduce it to a working pressure. Accordingly, the present invention is suitable for reducing a high pressure and a low-pressure. Depending on the type of pressure that is applied, an opening of the fluid passage may serve as a main opening or an outlet or as an inlet, wherein the by-pass opening is always to be passed through by a secondary stream or may be passed through by a secondary stream.

In particular, the fluid passage of the present invention comprises at least three openings—an inlet opening for the inflow of a fluid stream with an inlet pressure, a main opening at which a main stream of the fluid stream with the predetermined working pressure flows out or is present, and a by-pass opening from which a secondary stream of the fluid stream is discharged or into which a secondary stream flows in.

By having a secondary stream being discharged from the by-pass opening as provided by the present invention, a fluid stream flowing into the device according to the present invention is divided into the secondary stream and a main stream. The secondary stream is discharged from the fluid passage of the device to an outside environment, the main stream flows through the fluid passage to the main opening and discharged through the main opening and/or remains in the fluid passage under constant working pressure. By splitting the fluid stream into a main stream and a secondary stream, a working pressure at the main opening can be controlled very precisely.

Alternatively, a secondary stream flowing into the by-pass opening according to the invention may supplement a fluid stream flowing through the device to form a main stream, which may be sucked in by a pump, such as a vacuum pump. By supplementing the main stream with the secondary stream, flow characteristics, in particular of the fluid stream, may be controlled very precisely.

The by-pass opening according to the present invention may be an opening provided at the fluid passage of the present invention or a by-pass passage that leads into an opening provided at the fluid passage and connects the opening provided at the fluid passage to, for example, an outside environment of the device.

In particular, the division of a fluid stream flowing through the fluid passage of the present invention into a main stream and a secondary stream by means of a by-pass opening enables an inlet pressure of the fluid stream, which is subject to an input variance caused, for example, by a respective pump, to be reduced by a controlled branching of a secondary stream or a compulsory leakage, so that the resulting main stream flows or is present with a defined reduced working pressure and, in particular, a minimum variance. This means that the present invention can provide a particularly uniform working pressure or a working pressure with a minimum variance, which shows no or only minimal pressure variations, for example due to manufacturing tolerances and/or environmental conditions.

For dividing a fluid stream flowing through the fluid passage of the device according to the present invention into main stream and secondary stream, the device according to the present invention comprises a by-pass opening. In particular, the by-pass opening is arranged in such a way that it can divert a large or strong secondary stream from the fluid stream to be able to set a reduced and precise working pressure even at high inlet pressures. In order to enable a monitoring, i.e. a control or setting of the working pressure at which the main stream is discharged from the main opening of the present invention or is applied to the main opening, a magnitude or a flow characteristic of the secondary stream can be changed by means of the adjustment unit provided in accordance with the invention. For this purpose, the by-pass opening can be gradually or continuously reduced or enlarged by overlapping with the adjustment unit, so that less or more fluid or a smaller or larger secondary stream is discharged into the outside environment and, as a result, more or less fluid remains in the main stream which is then discharged from the main opening at high or low pressure.

The fluid passage may comprises a first region and at least a second region, wherein the first region is leading the secondary stream to the by-pass opening to adjust a working pressure in the second region.

The adjustment unit reduces a flow area of the by-pass opening by overlapping it at least in some areas. For this purpose, the adjustment unit can be positioned over the by-pass opening. In particular, the adjustment unit can be overlapped by the by-pass opening by means of an opening of the adjustment unit, so that a by-pass stream flowing through the by-pass opening is, for example, reduced or limited by the opening of the adjustment unit and, as a result, a working pressure in the fluid passage is increased compared to an unreduced by-pass opening.

In the case of a low-pressure, the adjustment unit can release a larger flow area of the flow opening in order to guide a larger secondary stream into the fluid passage and reduce a low-pressure in the fluid passage to a working pressure.

By selecting a respective opening of the adjustment unit for overlapping the by-pass opening according to the invention, the working pressure of a fluid flowing through the fluid passage of the present invention may be acted upon in such a way that by selecting particularly large openings a particularly strong reduction of the working pressure takes place and by selecting particularly small openings a particularly small reduction of the working pressure takes place. Accordingly, by changing the opening or by positioning the adjustment unit according to the invention, a successive adjustment of the working pressure can be achieved.

Depending on the type of fluid provided by the device or the inlet pressure to which the fluid is subjected, the device can be used to set a low-pressure or a high-pressure.

It can further be provided that the at least one opening of the adjustment unit is arranged to be gradually tapered.

By means of a gradually tapering opening of the adjustment unit, which can be arranged, for example, in the form of a triangle or in the form of a drop, a continuous, i.e. gradual, change of a secondary stream may be achieved, so that step-like changes of a corresponding working pressure are avoided and the working pressure may be adjusted particularly precisely.

Furthermore, the adjustment unit can have an eccentric-like guide that can adjust a trajectory of an outer circumference during a rotation thereof. Therefore, the by-pass opening may be increasingly or gradually overlapped or released by the adjustment unit, and a secondary stream flowing through the by-pass opening may be continuously reduced or increased accordingly.

The at least one opening may be arranged as a plurality of boreholes with different diameters.

By providing a plurality of bores of different sizes, a gradual change of a secondary stream may be achieved, which can be adjusted particularly quickly or easily.

The adjustment unit may further be movable between a closing position and a plurality of working positions, wherein the adjustment unit at different working positions among the plurality of working positions reduces the flow area of the by-pass opening with respective different overlapping areas.

The adjustment unit may be adjusted quickly and easily by means of a plurality of predefined working positions. For example, a specific working position may be assigned to a respective opening or a respective opening area. Accordingly, the adjustment unit may be positioned between different working positions, for example, using a mechanism, by rotating the adjustment unit about an axis, such as a rotation axis of the adjustment unit.

By providing a closing position, in which the by-pass opening is completely closed or covered, a maximum pressure in the fluid passage may be achieved.

The device may further comprises at least one inlet for introducing a fluid into the fluid passage.

According to the present invention, an inlet may be an opening or a port, such as a valve for connecting a fluid source. In particular, an inlet may be a connection to at least one pump. It is possible that an inlet of the present invention is arranged as an adapter element configured to connect a plurality of fluid sources or pumps.

The device may further comprise a pressure sensor for detecting a working pressure of a fluid being discharged from the main opening and an actuator for positioning the adjustment unit depending on measurements determined by the pressure sensor.

By using a pressure sensor and an actuator, an automatic control, i.e. an automatic control in the form of a control loop for positioning the adjustment unit according to the invention, may be provided. For example, the actuator may be controlled in such a way that a predetermined working pressure and/or a predetermined variance of the working pressure and/or a minimum deviation from a predetermined set pressure is achieved.

The adjustment unit may further comprise at least one latching element which interacts with a corresponding latching element in a working position of the adjustment unit to secure the adjustment unit in a certain rotational position or working position.

By using a latching element and a corresponding latching element, such as a ball head and a holder or a magnet with a first pole and a magnet with a corresponding second pole, or any other type of connecting elements, it is possible to secure the adjustment unit in a predetermined working position, thus eliminating the need for time-consuming fine adjustments.

The device of the present invention may further comprise at least one sealing element which impermeably seals a region between the adjustment disc and a region of the fluid passage forming the by-pass opening.

In order to prevent or reduce leakage between the adjustment unit and the fluid passage when fluid is discharged from the by-pass opening, a sealing element, such as a sealing ring, may be provided between the adjustment unit and the by-pass opening, in particular in the region around the opening of the adjustment unit.

In a second aspect, the present invention relates to the use of a device for adjusting a working pressure of a fluid provided by at least one pump.

In a third aspect, the present invention relates to the use of a device for setting a plurality of working pressures of a pressure sequence on a disk repair tool.

In a fourth aspect, the present invention relates to a method for adjusting a working pressure in a system. The method comprises the steps of providing a fluid pressurized with an input pressure, and/or positioning an adjustment unit of a device of the present invention into an operating position in which the adjustment unit overlaps the by-pass opening and reduces the flow area of the by-pass opening.

The method according to the present invention serves in particular for operating the device according to the present invention.

The adjustment unit may be moved between different working positions in which the by-pass opening is overlapped with different overlapping areas or openings of different sizes, respectively, so that the main stream of the fluid flows through the fluid passage at different overlapping areas with different flow characteristics or a different working pressure is applied to the main opening.

A sequence of different working pressures may be generated by positioning the adjustment unit, for example according to a predetermined sequence of movements or overlapping areas or different openings, which are positioned to overlap the by-pass opening according to the invention. In particular, the adjustment unit may be moved between a closing position, in which no fluid is discharged from the by-pass opening, and a plurality of different or identical working positions, so that a predetermined working pressure sequence is generated. Depending on the shape of the respective openings of the adjustment unit, a gradual or continuous transition between different pressure phases may be achieved.

Furthermore, the adjustment unit may be moved automatically, by means of an actuator controlled depending on a pressure in a main stream of the device according to the present invention which is detected by a pressure sensor.

By evaluating a working pressure of a fluid being discharged from or being present at the main opening of the device according to the present invention, a dynamic adjustment of a secondary stream may be provided, so that, for example, temporary variances, such as day-time dependent or temperature dependent pressure differences, may be efficiently and fully automatically compensated.

In a further aspect, the invention relates to a system, in particular a damaged area repair system. The system comprises at least one pump for providing a fluid having an inlet pressure and device according to the present invention for reducing the inlet pressure to at least a predetermined working pressure.

The system may comprise a damaged area repair tool. The damage repair tool is to be pressurized by the at least one pump with a pressure which is adjustable by the device according to the present invention.

A working pressure as set by using the device according to the present invention is particularly advantageous for operating a damaged area repair system, especially for repairing glass panes. Since high-pressure or low-pressure caused by variations is avoided or reduced by using the device according to the present invention, damage to a glass pane is thus virtually ruled out.

The invention thus allows a permanent, highly accurate, simple and/or fast adjustment of a working pressure in a system. Therefore, it is also possible to replace a plurality of pumps with a single pump, thereby saving costs and simplifying the system.

Further advantages, features and details of the invention will be apparent from the following description, in which examples of embodiments of the invention are described in detail with reference to the drawings. In this context, the features mentioned in the claims and in the description may each be essential to the invention individually or in any combination.

### DESCRIPTION OF THE DRAWINGS

FIG. 1 a possible embodiment of the device according to the invention,

FIG. 2 a side view of the adjustment unit according to the invention,

FIG. 3 a perspective view of the adjustment unit,

FIG. 4 a further possible arrangement of the adjustment unit according to the invention.

### DETAILED DESCRIPTION

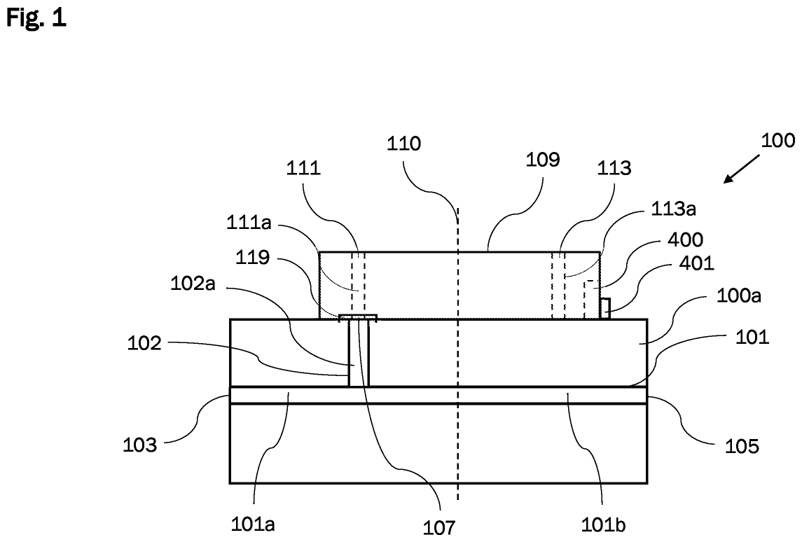

FIG. 1 shows a device 100 for adjusting a pressure in a system.

The device 100 comprises a fluid passage 101 with an inlet 103, a main opening 105 and a by-pass opening 107.

The device 100 further comprises an adjustment unit 109 having at least a first opening 111 and a second opening 113. The adjustment unit 109 further comprises at least a first passage 111a and a second passage 113a.

A secondary fluid passage 102 with a by-pass opening 107 is provided at the fluid passage 101 for adjusting a working pressure of a fluid being discharged the fluid passage 101 from the main opening 105 or being in contact with the main opening 105.

Through the by-pass opening 107, in the case of a high inlet pressure, a fluid stream 101a, which flows with an inlet pressure into the fluid passage 101 via the inlet 103, is divided into a secondary stream 102a and a main stream 101b. Thus, the flow characteristics of the main stream 101b, in particular its working pressure, may be influenced by adjusting the secondary stream 102a.

Alternatively, in the case of a low-pressure, a fluid stream 101a flowing through the fluid passage 101 is supplemented with a secondary stream 102a through the by-pass opening 107 in order to reduce the low-pressure, i.e. to shift it towards a higher value.

To adjust the secondary stream 102a, the adjustment unit 109 according to the present invention is provided. For example, since the first opening 111 has a smaller diameter than the second opening 113, the first opening 111, when positioned to overlap with the by-pass opening 107, causes a small secondary stream 102a, or a secondary stream 102a that is smaller, or has a smaller volumetric flow, than a secondary stream 102a produced when the by-pass opening 107 is overlapped by the second opening 113.

By branching off the secondary stream 102a from the fluid stream 101a flowing into the fluid passage 101, variances, such as pressure peaks in which a particularly large amount of fluid flows through the fluid passage 101, are automatically intercepted or buffered. Accordingly, after the secondary stream 102a has been branched off, the main stream 101b shows a particularly uniform pressure curve or a low variance, in particular a variance that is smaller than the variance of the fluid stream 101a flowing into the fluid passage 101 through the inlet 103.

Depending on the desired working pressure and/or the applied inlet pressure, it is possible to switch at least between the first opening 111 and the second opening 113 by moving the adjustment unit 109 or rotating it about an axis 110. Accordingly, in order to set a low working pressure, for example, the second opening 113 can be selected with a large diameter for overlapping the by-pass opening 107. Alternatively, in order to set a high working pressure, the first opening 113 with a small diameter can be selected for overlapping the by-pass opening 107.

The adjustment unit 109 can be moved automatically by means of an optional actuator to switch between the openings 111 and 113. For this purpose, the actuator 115 can be controlled or set depending on measurements of a working pressure or an inlet pressure determined by using an optional pressure sensor or the like.

A sealing unit 119 is provided between the adjustment unit 109 and the secondary fluid passage 102, which can be provided to prevent leakage of a fluid when flowing through one of the openings 111 or 113 of the adjustment unit 109. This can ensure that an impermeable connection is provided between a base member 100a and the adjustment unit 109 after the adjustment unit 109 has been adjusted.

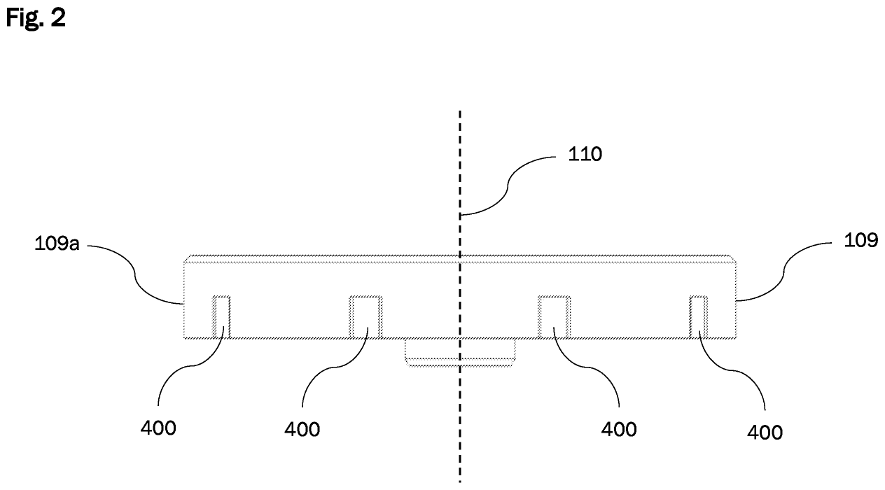

FIG. 2 shows a side view of the adjustment unit 109. Indentations 400 are provided on an outer circumference 109a. In the predetermined working positions, in which openings 111, 113 are arranged above the by-pass opening 107, a latching element 401 (see FIG. 1) can engage in an indentation 400 and thereby permanently secure the position of the adjustment unit 109 relative to the by-pass opening 107. This allows the position of the adjustment unit 109 to be set and then secured in an optimal manner.

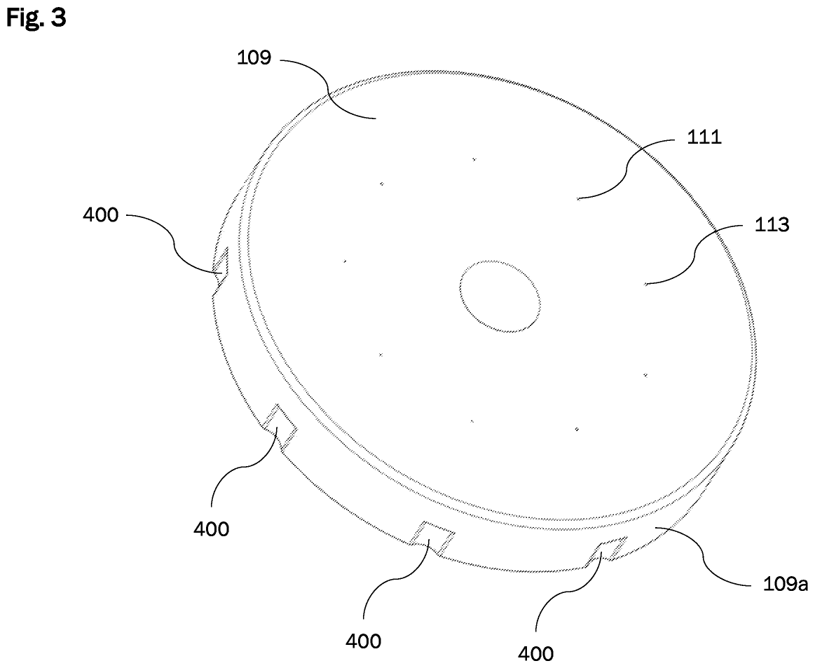

FIG. 3 shows a perspective view of the adjustment unit 109. Several openings 111, 113 with different diameters are provided on the upper side. The graduations of the diameters can be selected, for example, so that a pressure difference in the fluid passage 101a or at the main opening 105 has a value of 1/10 bar. The following diameters are merely non-limiting examples: 0.130, 0.140, 0.150, 0.160, 0.170, 0.180, 0.190, 0.200, 0.210 mm.

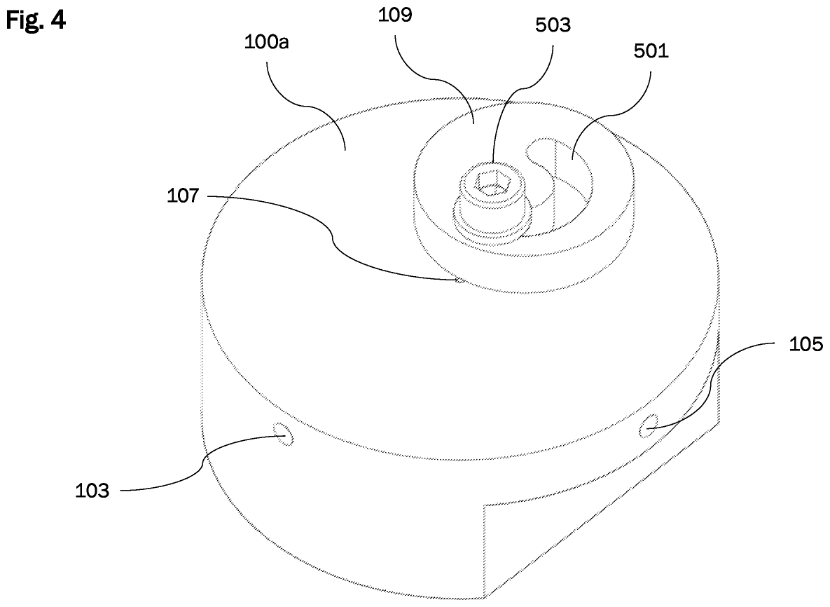

FIG. 4 shows a further arrangement of the adjustment unit 109 with an eccentric guide passage 501 and a clamping element 503 which engages in the guide passage 501. By moving the adjustment unit 109 along the clamping element 503, which is positionally secured with respect to the base element 100a, the adjustment unit 109 moves along a trajectory predetermined by a shape of the guide opening 501, which is characteristic of an eccentric, for example. The predetermined trajectory may be selected such that the adjustment unit 109 overlaps a by-pass opening 107 according to a predetermined characteristic. In particular, the trajectory may be selected to be linear or rotational. Once the appropriate degree of overlap of the by-pass opening 107 has been set, the clamping element 503 can secure the adjustment unit 107 relative to the base element 100a via a screw.

The pressure applied to the main opening 105 is adjusted by means of the overlapped or covered flow area of the by-pass opening 107, so that a predetermined working pressure is established at the main opening 105.

### LIST OF REFERENCE SIGNS

100 device

100a base element

101 fluid passage

101a fluid stream

101b main stream

102 secondary fluid passage

102a secondary stream

103 inlet

105 main opening

107 by-pass opening

109 adjustment unit

109a outer circumference

110 axis

111 first opening

111a first passage

113 second opening

113a second passage

119 sealing unit

400 indentation

401 latching element

501 guide passage

503 clamping element

1. A device for adjusting a pressure in a system, wherein the device comprises:
at least one adjustment unit having at least one opening,
a fluid passage, wherein
the fluid passage comprises an inlet, a by-pass opening for discharging a secondary stream of a fluid flowing through the fluid passage to an outside environment of the device, and a main opening, and wherein
the adjustment unit is configured to, in a working position, overlap the by-pass opening with the at least one opening and thereby reduce the flow area of the by-pass opening with the at least one opening.

2. The device according to claim 1, wherein
the at least one opening is configured as a plurality of boreholes having different diameters.

3. The device according to claim 1, wherein
the at least one opening of the adjustment unit is configured to gradually taper.

4. (canceled)

5. The device according to claim 1, wherein
the adjustment unit reduces the flow area of the by-pass opening in different working positions using different overlapping areas, respectively.

6. The device according to claim 1 any one of the preceding claims, wherein
the adjustment unit comprises at least one indentation which interacts with a latching element in a working position of the adjustment unit to secure the adjustment unit in a desired rotational position.

7. The device according to claim 1, wherein
a pressure sensor for detecting a pressure in the main stream and an actuator for moving the adjustment unit depending on measured values determined by the pressure sensor are provided.

8. The device according to claim 1, wherein
the device comprises at least one sealing unit which seals a region between the adjustment unit and a region of the secondary fluid passage forming or surrounding the by-pass opening substantially impermeably.

9. A method of using the device according to claim 1 including adjusting a pressure of a fluid provided by at least one pump.

10. A method of using the device according to claim 1, including setting a plurality of working pressures of a pressure sequence on a disk repair tool.

11. A method for adjusting a pressure in a system, wherein the method comprises the steps of:
providing a fluid pressurized with an input pressure,
positioning an adjustment unit of a device according to claim 1 at an operating position in which the adjustment unit overlaps the by-pass opening and reduces the flow area of the by-pass opening

12. The method according to claim 11, wherein
the step of positioning the adjustment unit to overlap the by-pass opening is automatically executed using an actuator depending on a working pressure in a main stream of the device detected by a pressure sensor.

13. A system, comprising:
at least one pump for providing a fluid having an input pressure,
a device according to claim 1 configured to reduce the pressure at a main opening to at least a predetermined working pressure, wherein
the device comprises an inlet for connecting said at least one pump.

14. The system according to claim 13, wherein
the system comprises a repair tool, and wherein
the repair tool is configured to be pressurized by said at least one pump with a working pressure which is adjustable by said device.
